(19) United States
(12) Patent Application Publication
(10) Pub. No.: US 2006/0104627 A1
(43) Pub. Date: May 18, 2006

(54) Apparatus and method for excluding vignetting in a digital camera

(75) Inventor: Jung-Hoon Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/272,062

(22) Filed: Nov. 14, 2005

(30) Foreign Application Priority Data
Nov. 12, 2004 (KR) 10-2004-0092620

(51) Int. Cl. G03B 7/08

(52) U.S. Cl. 396/234

(57) ABSTRACT

An apparatus and method is provided for excluding vignetting occurring during wide-angle shooting using a camera. When a focal length of the camera is computed and an ISO range is set using a result of measuring an amount of light, a view angle wider than the inherent view angle of a camera module can be provided. Therefore, vignetting can be removed and an image of an area wider than the current capture range can be captured.

### CROSS-REFERENCE TO RELATED APPLICATIONS

This application claims the benefit under 35 U.S.C. §119(a) of Korean Patent Application No. 10-2004-0092620 entitled “Apparatus and Method for Excluding Vignetting in a Digital Camera” filed in the Korean Intellectual Property Office on Nov. 12, 2004, the entire disclosure of which is incorporated herein by reference.

### BACKGROUND OF THE INVENTION

1. Field of the Invention

The present invention generally relates to wide-angle photography using a camera. More particularly, the present invention relates to an apparatus and method for excluding vignetting occurring during wide-angle shooting using a camera.

2. Description of the Related Art

Conventionally, cameras are classified into film cameras and digital cameras. Film cameras can be further classified according to a film size and type. Digital cameras are further classified as general digital cameras, digital single lens reflex (DSLR) cameras using the SLR principle of the film camera, and so on.

A lens of the SLR camera can be replaced as in the film camera and can include various lens types. Lenses are divided into telephoto lens, macro lens, standard lens, wide-angle lens, fisheye lens, and so on. Here, the telephoto lens has the effect of making subjects seem closer than they actually are, and is different from that of digital zoom. The macro lens enables a still image to be accurately captured from an extremely close distance, for example, from a shooting distance as close as 1 cm, and enhances image sharpness. The standard lens has the same perspective as the human eye. The thickness and length of the standard lens are closest to those of the lens of the normal human eye. In the case of 35 mm film, the standard lens has a focal length between approximately 50 and 55 mm. The macro or fisheye lens sees a wider perspective than the human eye generally sees. The macro or fisheye lens is used to project a background of a wider area on the same sized film or a light-sensitive sensor such as a charge-coupled device (CCD), and so forth.

Each of these lenses have merits and drawbacks. A user selects a suitable lens while considering a drawback according to a use purpose and then prepares to take pictures. Because the telephoto lens has a long focal length, it is subject to any small camera shake that causes an image to blur. To address this problem, the telephoto lens of high magnification uses a tripod. Similarly, the macro lens is also subject to any small camera shake. The sharpness of a subject image is important in the characteristics of the macro lens. Conventionally, the macro lens has a focal length of approximately 100 mm. In this case, a shutter speed of 0.01 seconds corresponding to the reciprocal of 100 mm must be ensured. This case corresponds to International Standards Organization (ISO) 100 indicating the sensitivity of an image sensor.

In addition to the telephoto lens and the macro lens as described above, another lens that can be used for capturing an image of a wide scene is the wide-angle lens or the fisheye lens. Because the fisheye lens has severe distortion, it is used only in a special case. The wide-angle lens has a focal length of approximately 15 mm in the case of 35 mm film. A shooting range of the 15 mm wide-angle lens has an angle of 115 degrees in front of the camera. An angle of view varying with the focal length of this lens is illustrated in FIG. 1. Vignetting according to the view angle will now be described with reference to FIG. 1.

When an incident angle (view angle) is large as in the case of the lens, an aperture is reduced to capture a totally clear image in a range of a near distance to a far distance and a lens rim that is unused in a general case, is then used. An amount of light incident on the lens rim is less than that incident on the lens center. Vignetting is often found in an image captured by means of the wide-angle lens. That is, vignetting is a phenomenon in which an edge or outer part of an image is darkened due to a reduced amount of light on the lens periphery.

Vignetting may occur in a case where a lens itself has vignetting and in a case where an accessory such as a converter or filter is mounted. In the former case, light passing through the lens forms a circular image. A circle of the formed image is referred to as an image circle. Because the diameter of the image circle is shorter than the diagonal length of the captured image, no image is formed at the edge and therefore vignetting occurs. In the latter case, vignetting in many digital cameras occurs on a wide-angle side in which a focal length is short. That is, vignetting occurs because a focal length difference between the lens center and the lens periphery is significantly large on the wide-angle side. When a long lens hood or a narrow hood as compared with a view angle of the lens is used, the hood covers the comers of an image, resulting in vignetting.

To address the vignetting problem, optical technology is used. A suitable conventional lens combination is made to address the vignetting problem. In this case, there is a problem in that chromatic aberration occurs because a lens area increases. To remove vignetting or chromatic aberration, the characteristics of light are conventionally used in the lens combination.

Because the lens combination requires high optical technology to remove the vignetting effect in the lens combination, its cost increases. Moreover, the lens combination has a problem in that a lens barrel length and a lens area increase when concave and convex lenses and light refraction are used.

Because a focal length is very short in the general digital camera, an image may be captured in landscape mode and so on. However, a range of the image captured in the landscape mode is narrow as compared with that of an image capable of being captured through a wide-angle lens mounted in an SLR camera. The general digital camera can conventionally take pictures only within a range in which the vignetting effect does not occur in a fabrication process as illustrated in FIG. 2.

However, a structure of a camera module used in a mobile camera is simpler than that of the general digital camera. Also, since a focal length of the camera module of the mobile camera is shorter than that of the general digital camera, a shooting range of the camera module is limited. Further, since the small-sized camera module has problems related to size and structure, it is difficult for a camera aperture to be mounted in the camera module. Accordingly, vignetting is commonly found in an image captured by a mobile phone with the widely used camera module. However, there is still another problem in which a shooting angle is very narrow even when vignetting is not present in the widely used camera module.

Accordingly, a need exists for a system and method for excluding vignetting occurring during camera use.

### SUMMARY OF THE INVENTION

It is, therefore, an object of embodiments of the present invention to substantially solve the above and other problems, and to provide an apparatus and method for excluding vignetting occurring during wide-angle shooting using optical technology.

It is another object of embodiments of the present invention to provide an apparatus and method for excluding vignetting through area-by-area control of an image sensor module in a device with a digital camera.

The above and other objects of embodiments of the present invention can be substantially achieved by an apparatus for excluding vignetting in a digital camera, comprising a vignetting processor for measuring a focal length and an amount of light for an image input from a lens, detecting vignetting and performing an image sensitivity compensation for a vignetting area, and an image capture unit for providing a user with an image based on information output from the vignetting processor.

The above and other objects of embodiments of the present invention can also be achieved by a method for excluding vignetting in a digital camera, comprising the steps of measuring a focal length and an amount of light for an image input from a lens, detecting vignetting and performing an image sensitivity compensation for a vignetting area, and providing a user with an image based on information output from a vignetting processor.

### BRIEF DESCRIPTION OF THE DRAWINGS

The above and other objects and advantages of the present invention will become more clearly understood from the following detailed description taken in conjunction with the accompanying drawings, in which:

FIG. 1 illustrates an angle of view varying with a focal length of a lens in a camera device;

FIG. 2 illustrates a conventional image sensor module and a vignetting range;

FIG. 3 is a block diagram illustrating an apparatus for excluding vignetting in a digital camera in accordance with an embodiment of the present invention;

FIG. 4 illustrates exemplary parameters for computing a focal length in accordance with an embodiment of the present invention;

FIG. 5 illustrates exemplary measurement points used in a multi metering method in accordance with an embodiment of the present invention; and

FIG. 6 is a flowchart illustrating an exemplary operation for excluding vignetting in the digital camera in accordance with an embodiment of the present invention.

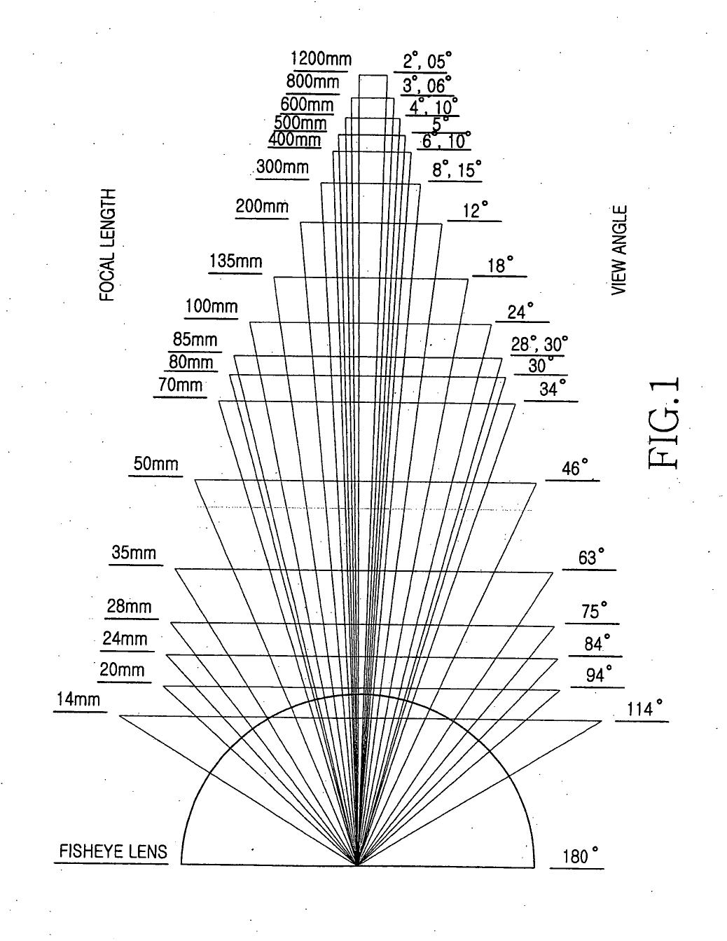

Throughout the drawings, like reference numerals will be understood to refer to like parts, components and structures.

### DETAILED DESCRIPTION OF EXEMPLARY EMBODIMENTS

Exemplary embodiments of the present invention will now be described in detail herein below with reference to the accompanying drawings. In the following description, detailed descriptions of functions and configurations incorporated herein that are well known to those skilled in the art are omitted for clarity and conciseness.

In the following description, an example of a digital camera will be described with a structure in which it is difficult to remove vignetting occurring during wide-angle shooting. It should be noted that embodiments of the present invention are equally applicable to any device in which wide-angle shooting is possible. First, an apparatus for excluding vignetting in a digital camera will be described with reference to the accompanying drawing.

FIG. 3 is a block diagram illustrating an apparatus for excluding vignetting in a digital camera in accordance with an embodiment of the present invention.

Referring to FIG. 3, the apparatus comprises a camera controller 310 for performing the overall control of the camera, a vignetting processor 320 for removing vignetting, and an image capture unit 330 for actually capturing an image.

The vignetting processor 320 comprises a vignetting controller 321 for determining if vignetting has been effectively removed when the entire image is completed, a camera lens 322, a light meter 323 for measuring an angle of view according to a change of a focal length due to optical zoom and an amount of current incident light, and an International Standards Organization (ISO) setting unit 324 for controlling the sensitivity of an image sensor (or an ISO rating).

Also, since the apparatus of an exemplary embodiment of the present invention does not perform a control operation during the use of a device with a camera module, but measures in advance an amount of light based on a focal length of a lens to use the measured light amount, a mapping table (not illustrated) is preferably required. Here, the mapping table (not illustrated) may be included in the vignetting processor 320.

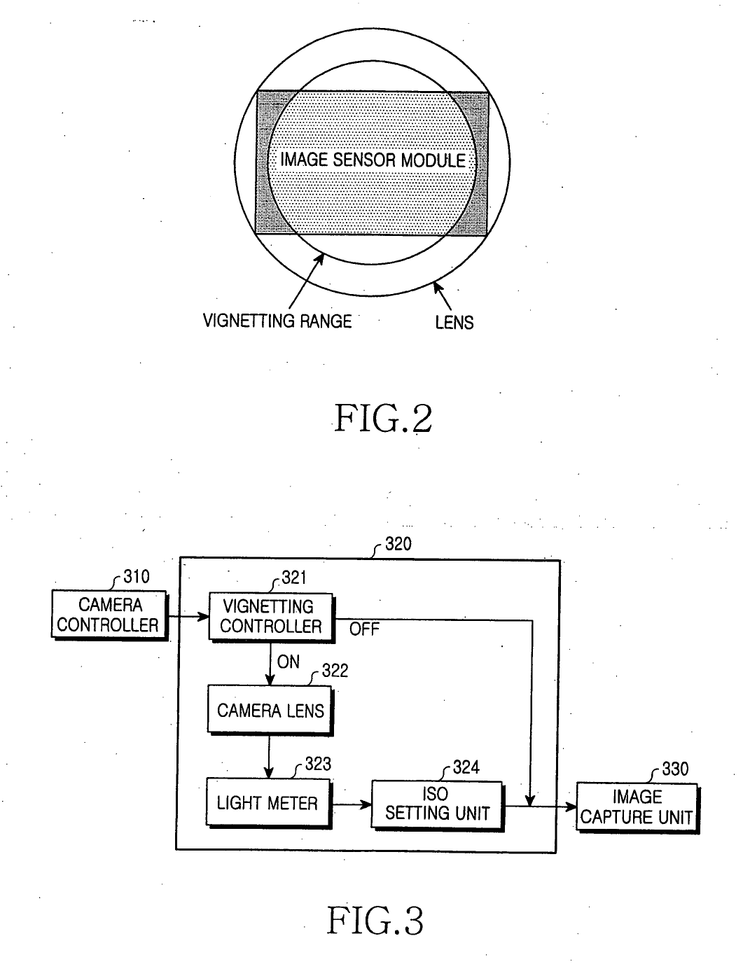

The image capture unit 330 performs a function for providing a user with an image from which vignetting has been removed in the vignetting processor 320, and an image based on image information of a directly input still or motion image. That is, the image capture unit 330 comprises an image display unit such as the image sensor module illustrated in FIG. 2.

An ISO rating conventionally used in a film camera indicates the sensitivity of a film. The film sensitivity is referred to as the photosensitivity and is the sensitivity of a film to light, that is, a film speed varying with light. The film sensitivity is used as a conversion value in a digital camera without a film. When film sensitivities are classified, ISO 25˜50 denotes low sensitivity, ISO 100˜200 denotes medium sensitivity, ISO 200˜400 denotes high sensitivity, and ISO 800˜3200 denotes ultra high sensitivity. When film sensitivity is high, an image capture operation is possible even in a state in which the amount of light is low. In this case, the use of a battery can be reduced because a flash does not need to be used. When film sensitivity is high, particles are rough and image quality decreases, resulting in noise.

When the use of the flash is difficult, for example, at sunset or inside a room, ISO sensitivity can be increased such that an image is captured. At normal times, ISO 100 is fixed and used. At the time of capturing an image of a night scene, a method for increasing the exposure time rather than the sensitivity is used. Many cameras are based on the standard sensitivity of ISO 100 because better images can be generally captured in ISO 100.

A method for excluding vignetting occurring during wide-angle shooting in an apparatus in accordance with an embodiment of the present invention having the above-described structure will now be described in greater detail with reference to the accompanying drawing.

First, when an aperture value is fixed in a process of fabricating a camera module, for example, an aperture value fixed in a camera module mounted in a mobile phone, a focal length in which vignetting occurs is measured in a situation in which optical zoom is not used.

Then, ISO sensitivity available in the vignetting processor 320 is computed in advance from the focal length in which vignetting occurs. The sensitivity of ISO 200 is twice that of ISO 100. The sensitivity of ISO 400 is twice that of ISO 200. The sensitivity of ISO 400 is four times that of ISO 100. If the image sensor module supports up to ISO 400, a focal length is computed in which light corresponding to a multiple of a quarter of the amount of light passing through the lens center is irradiated. A wide-angle focal length of more than the computed focal length cannot be supported in the image sensor module. Data of an image in which optical characteristics are poor may then be generated even though the increased focal length is supported by software. Programs currently being sold in the market aim at correcting a total exposure value according to lens characteristics and removing image distortion, because a determination cannot be accurately made as to whether data according to the above-described optical characteristics is associated with a problem of an arbitrary value of the user or with a problem of the device itself.

An image is input through the camera lens and digitally processed. Bit information mapped to pixels of the processed image is transferred to a medium for displaying or storing the image in a serial or parallel fashion. That is, one image is completed using pixel data. In the conventional lens structure, the lens is circular and the image sensor module is rectangular. One reason why the lens is circular in an optical design is that sufficient light is received and image distortion is small. One reason why the image sensor module is rectangular is that fabrication is easy and convenient and images are conventionally kept in the rectangular form.

Parts in which vignetting occurs are mostly rectangular edges. When a circular dark image is received, the image sensor module cuts the image in rectangular form but the dark image remains on four edges. This is because the amount of light incident on the lens is not uniform when an image is captured. Because a lens suitable for various environments cannot be configured for a camera module of a mobile phone, an ISO rating is adjusted when an image is captured. When a general camera captures an image in a dark room or in cloudy weather, the image captured by the general camera is dark as compared with that captured by a digital single lens reflex (DSLR) camera capable of addressing the above-described problem, and an amount of noise increases.

The computation of a focal length will now be described with reference to the accompany drawing.

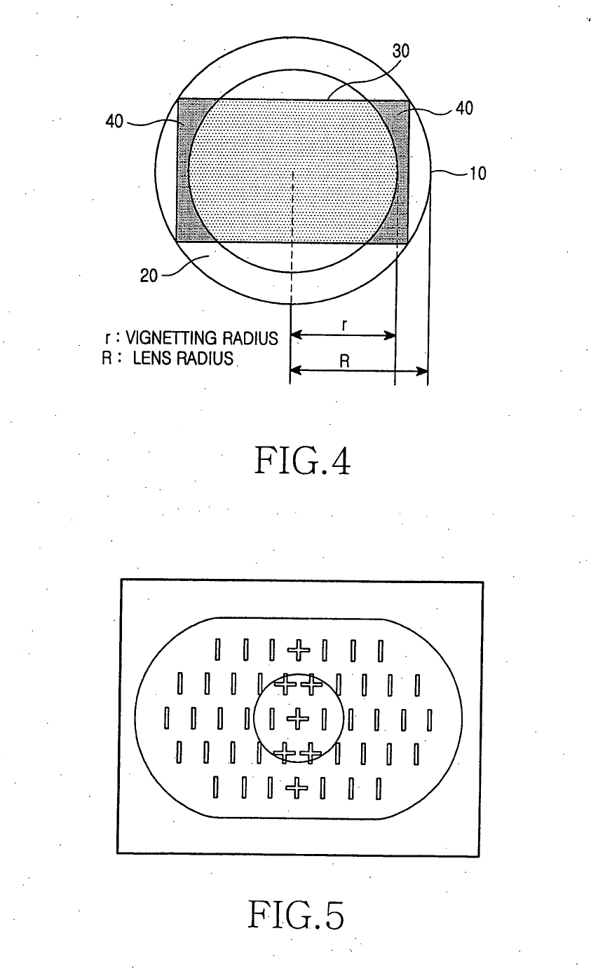

FIG. 4 illustrates exemplary parameters for computing a focal length in accordance with an embodiment of the present invention.

When the camera module is configured, the maximum size of an image sensor module 30 is set to be the same as a size of a lens 10 (with a radius R). The radius of a range 20 where vignetting starts to occur is set to r. A ratio of R and r in the image sensor module is typically 4:3, but is not limited thereto. Various other ratio values such as 16:9, and so forth, and square sensor modules can be implemented according to manufacturer specifications. Since the ratio simply varies with an image sensor size, a sensor module with the widely used ratio of 4:3 will be described as an example. Here, R is a fixed value and r varies with a focal length. If, for example, R is the same as r, vignetting does not occur. That is, a heavily shaded part 40 of FIG. 4 does not exist.

When the focal length decreases, that is, wide-angle shooting is performed, the r value decreases. Then, an area (V_{space}) of the heavily shaded part 40 increases. The r value increases because vignetting decreases when the focal length increases (or optical zoom is applied). In contrast, the r value decreases because vignetting increases when the focal length decreases (or optical zoom is not applied).

Vignetting does not equally occur in the shaded parts of FIGS. 2 and 4, and edges of the image sensor are dark. That is, an ISO value associated with the R−r area in the image sensor increases proportionally to the r value. The ISO value is varied as shown in Equation (1).
ISO≈k(R−r) Equation (1)

As described above, the ISO value is not set in a development process, but must be varied with an environment in which an image is captured. This is because image capture environments vary, and the amount of light incident on the lens varies with time and place. Accordingly, the amount of current incident light needs to be measured such that the ISO value is adjusted. To measure the light amount, an average metering method for measuring an average brightness value of the entire image or a multi-metering method for selecting two measurement points and computing an average brightness value between the two selected points is used. This multi-metering method will now be described with reference to FIG. 5 which illustrates an example of exemplary measurement points used in the multi-metering method.

As illustrated in FIG. 5, the multi-metering method conventionally uses several measurement points. A method for measuring an amount of light in a special single point is referred to as spot metering. This method uses a backlight mode to prevent an image of a subject from being dark when the image is captured in a state in which the sun is at the back of the captured image.

An embodiment of the present invention preferably uses another method that is different from the conventional metering method such that vignetting can be excluded. When a focal length is computed, an area in which vignetting occurs can be found through the specification of the current lens. When the light metering is performed for the area in which vignetting occurs, it can be found that the light amount of the entire image is lowered. In this case, an ISO value can be increased, but vignetting is difficult to exclude because the entire image is very brightly expressed according to the increased ISO value. To address this problem, the light metering is partially performed only for a range in which vignetting does not occur. That is, the light metering is performed only for a lightly shaded part 30 in the area 20 in which vignetting occurs as shown in FIG. 4. Accordingly, the final image with the brightness desired by the user is obtained without vignetting.

Assuming, for example, that an average brightness value measured in an area in which vignetting does not occur is B_mean and an ISO value determined by B_mean is ISO_mean, an increment ratio can be defined by Equation (2) below. In Equation (2), ISO_mod denotes an ISO value changed in an outer part of an image. The brightness of an area in which vignetting occurs is denoted by B_mod. Here, the magnitude of B_mod decreases in an outer part of the lens.
ISO_mod=ISO_mean*n(B_mean/n<B_mod<B_mean) Equation (2)

In Equation (2), n is an integer and B_mean /n is set to a maximum value less than or equal to B_mod. Assuming, for example, that ISO_mean determined by B_mean is 100 and ISO_mean is 150 in Equation (2), an exemplary ISO range can be set as follows. If B_mod is 100, the ISO range has a value between about 150 and about 75 (that is, where 75=150/2). In this case, the n value is 2. Then, the ISO_mod value of 200 is obtained by multiplying ISO_mean by a change coefficient of n (=2). If B_mod is 50, the ISO range exists between about 150 corresponding to the total average brightness, and about 37.5 (that is, where 37.5=150/4). In this case, the n value is 4. Then, the ISO_mod value of 400 is obtained by multiplying ISO_mean by a change coefficient of n (=4).

If a symmetric form of the lens and a square form of the film are considered when the apparatus for excluding vignetting in accordance with an embodiment of the present invention is implemented, the light metering is preferably performed for only one of four edges rather than for all four edges, except in a special case such as the case where the sunlight is incident on a specific position. If the brightness values of the four edges measured in the light metering are similar to each other, the light metering is performed for only one of the four edges rather than all of the four edges, a changed ISO value is set for the one edge, and the set ISO value is equally applied for the remaining three edges. Thus, an amount of computation load is reduced by about 25%.

A procedure of the above-described method for excluding vignetting will now be described with reference to the accompanying drawing.

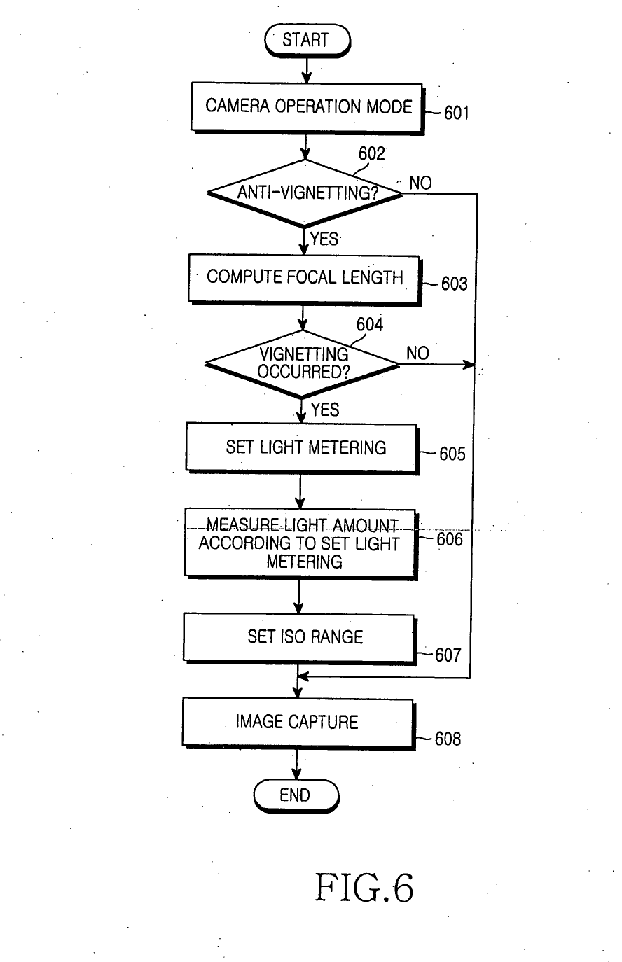

FIG. 6 is a flowchart illustrating an exemplary operation for excluding vignetting in a digital camera in accordance with an embodiment of the present invention.

When an exemplary digital camera is in operation in step 601 of FIG. 6, the vignetting processor 320 determines if vignetting needs to be excluded in step 602. This comprises acknowledging if a process is desired for the case where the user wants to intentionally generate vignetting.

If vignetting does not need to be excluded as a result of the determination in step 602, the operation proceeds to step 608 in which information is provided such that the image capture unit 330 can capture an image. If an anti-vignetting algorithm is turned on, that is, the vignetting needs to be excluded, as a result of the determination in step 602, the vignetting processor 320 computes a focal length based on optical zoom in step 603.

Then, the vignetting processor 320 determines if vignetting has occurred in step 604. If vignetting has not occurred as a result of the determination, the operation proceeds to step 608. If vignetting has occurred, the vignetting processor 320 sets a light metering method in step 605 and then measures an amount of incident light according to a light metering method selected from average metering, multi-metering (spot metering), partial metering, and so on, in step 606.

In step 607, the vignetting processor 320 sets an ISO range and value using the measured light amount and the computed focal length and makes a partial ISO change. In step 608, the image capture unit 330 captures an image.

As described above, embodiments of the present invention comprise an image sensor module (of a CCD or CMOS) to exclude vignetting through area-by-area control in a digital camera. Since a view angle (or shooting angle) provided from a small-sized digital camera module can be widely utilized, an image of an area that is wider than a shooting range can be captured. When embodiments of the present invention are applied to a mobile phone camera with a camera module in which a lens is very small, vignetting can be effectively removed without using high optical technology.

As described above, embodiments of the present invention compute a focal length of a camera and set an ISO range using a result of measuring an amount of light, thereby providing a view angle that is wider than the inherent view angle of a camera module. Therefore, vignetting can be removed and an image of an area wider than the current capture range can be captured.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An apparatus for excluding vignetting in a digital camera, comprising:
a vignetting processor for measuring a focal length and an amount of light for an image input from a lens, detecting vignetting, and performing an image sensitivity compensation for a vignetting area; and
an image capture unit for providing a user with an image based on information output from the vignetting processor.

2. The apparatus of claim 1, wherein the vignetting processor comprises:
a vignetting controller for determining if an operation for excluding vignetting is required;
a camera lens for capturing the image;
a light meter for computing an amount of current incident light; and
an image sensor sensitivity setting unit for setting a sensitivity range and value of an image sensor using the measured light amount and the computed focal length.

3. The apparatus of claim 2, wherein the light meter is configured to measure light amounts in an area in which vignetting occurs and an area in which vignetting does not occur.

4. The apparatus of claim 3, wherein the image sensor sensitivity setting unit is configured to perform the compensation according to an image sensitivity difference between the area in which vignetting occurs and the area in which vignetting does not occur.

5. The apparatus of claim 4, wherein the light meter is configured to measure an amount of light in the area in which the vignetting occurs in the image by measuring an amount of light in one of areas in which the vignetting occurs and equally apply the measured light amount for remaining areas.

6. A method for excluding vignetting in a digital camera, comprising the steps of:
measuring a focal length and an amount of light for an image input from a lens, detecting vignetting, and performing an image sensitivity compensation for a vignetting area; and
providing a user with an image based on information output from a vignetting processor.

7. The method of claim 6, further comprising the step of:
initially determining if an operation for excluding vignetting is required when the image is captured.

8. The method of claim 7, further comprising the step of:
performing a compensation based on the measured light amount according to an image sensitivity difference between an area in which vignetting occurs and an area in which vignetting does not occur.

9. The method of claim 8, further comprising the step of:
performing an operation for measuring an amount of light in the area in which vignetting occurs in the image by measuring an amount of light in one of areas in which vignetting occurs and equally applying the measured light amount for remaining areas.
